(19) United States
(12) Patent Application Publication
(10) Pub. No.: US 2016/0132916 A1
(43) Pub. Date: May 12, 2016

(54) SYSTEM AND METHOD OF DEMAND MODELING AND PRICE CALCULATION BASED ON COMPETITIVE PRESSURE

(71) Applicant: Clear Demand, Inc., Scottsdale, AZ (US)

(72) Inventor: Adam N. ROSENBERG, Scottsdale, AZ (US)

(73) Assignee: CLEAR DEMAND, INC., Scottsdale, AZ (US)

(21) Appl. No.: 14/936,804

(22) Filed: Nov. 10, 2015

Related U.S. Application Data
(60) Provisional application No. 62/123,159, filed on Nov. 10, 2014.

(51) Int. Cl. G06Q 30/02

(52) U.S. Cl. CPC G06Q 30/0206

(57) ABSTRACT

A method and apparatus for demand modeling and price calculation based on competitive pressure is provided. Data related to a plurality of products related to a product of interest is collected, along with the number of sales, sales price and one or more product attribute values for each of the products. Conversion factors are used to equivalize the plurality of products relative to the product of interest, and attribute weights characterize product relevance to the product of interest. Based on these factors, a competitor pressure model is generated for the product of interest and describes its estimated variation in demand as a function of its variation in price. The competitor pressure model may be used to evaluate the effect of proposed price changes and correct the proposed price changes by calculating an optimal price.

### CROSS-REFERENCE TO RELATED APPLICATIONS

This application claims priority to and the benefit of U.S. Provisional Patent Application No. 62/123,159, filed Nov. 10, 2014, the contents of which are incorporated by reference in their entirety as if fully set forth herein.

### FIELD OF THE INVENTION

The present invention relates to demand modeling and price calculation, and more specifically to apparatus and methods for demand modeling and price calculation based on competitive pressure.

### BACKGROUND

In retail science, optimization of prices (with respect to a revenue or profit target), markdown, promotion, replenishment, or assortment typically relies on a shopper-demand forecast, i.e., a demand model. That is, one requires some prediction of how many units will sell, typically by product, store, time, and promotion status. Output parameters of a demand model include elasticity and scale for regular sales and promotion along with seasonality, cannibalization, affinity, pantry loading, cherry picking, and other shopper behavior. Typically, the model input variable of price is controllable. In particular, demand is traditionally modeled as a function of price and then that modeled demand is used to choose the best price to achieve one or more retail goals.

### SUMMARY

Embodiments of the invention are directed to a computer-implemented method for analyzing the competitor pressure generated by a plurality of products on a product of interest, and subsequently determining a demand model that may be used to calculate optimal prices.

In a first embodiment of the invention, a method is provided. In the method a number of product sales and corresponding prices over a selected time period are collected, with each product being described by one or more attributes and attribute values. The method also involves using conversion factors are used to equivalize the prices and values of different products with respect to a product of interest, and attribute weights are applied to each product attribute to characterize its relevancy in terms of corresponding to the product of interest. Based on the number of sales, the equivalized prices and values, and the attribute weights, a model of competitor pressure is generated for the product of interest in the method, which describes an estimated variation in demand for the product of interest as a function of its variation in price.

In the first embodiment, the effect of a proposed price change for the product of interest can be estimated using the competitor pressure model and the proposed price change.

In the first embodiment, the competitor pressure model can be selected to have a form comprising an S-function.

In the first embodiment, the plurality of related products can be associated with a plurality of sources.

In the first embodiment, the computer-implemented method further can include calculating an optimal price for a product associated with the plurality of related products using:

P*=+λC+1/\hat{β}

where P* is the optimal price, C is a cost of the product, λ is a weighted average of revenue and profit, and 1/\hat{β} is a willingness-to-pay amount, where \hat{β}=β+β₁−β₂·β₂·₁ is a factor describing outside competitor pressure, β₂ is a factor describing cannibalization, and β is a non-competitive factor according to:

D=Qe^{-τ}^{ᵢ}^{γ}^{ᵢ}^{p}^{ᵢ}^{^{−βP}}

where D is observed demand for the product of interest during the selected time period, P is the rice for the product of interest during the selected time period, pᵢ is the competitor pressure of an ith of the plurality of products according to the model during the selected time period, and γᵢ is an elasticity term for the ith of the plurality of products during the selected time period, and Q is a scale term describing demand when P=0.

In the first embodiment, the outside competitor pressure factor (β₁) can be defined by:

$${β}_{1} = {\sum }_{i} {γ}_{i} \frac{d {p}_{i}}{d P}$$

wherein the plurality of products for generating the competitor pressure model for obtaining γᵢ and pᵢ are associated with one or more sources other than a source of the product of interest.

In the first embodiment, the cannibalization factor (β₂) can be defined by:

$${β}_{2} = {\sum }_{j} {γ}_{0 , j} \frac{d {p}_{0 , j}}{d P} \frac{( {P}_{j} - λ {C}_{j} )}{( P - λ C )} \frac{{w}_{j}}{{w}_{0}}$$

where Pⱼ is a price of a jth one of the plurality of related products during the selected time period, Cⱼ is a cost of the jth one of the plurality of related products during the selected time period, γ_{0,j} is an elasticity term for the jth one of the plurality of products from a source of the product of interest, p_{0,j} is the competitor pressure for the jth one of the plurality of products from the source of the product of interest, and wⱼ/w₀ is a weight reflecting the relative importance of the the jth one of the plurality of products from the source of the product of interest, wherein the plurality of products associated with the competitor pressure model for obtaining γ_{0,j} and p_{0,j} are associated with the source of the product of interest.

In the first embodiment, the calculating γᵢ for each of the plurality of products can be based on a regression analysis of:

D=Qe^{-τ}^{ᵢ}^{γ}^{ᵢ}^{p}^{ᵢ}^{^{−βP}}.

In a second embodiment of the invention, a non-transitory computer readable medium is provided and contains instructions for causing a computer to perform the steps of the method of the first embodiment.

In a third embodiment of the invention, a computer system is provided, and comprises a storage device containing data on a number of product sales and corresponding prices over a selected time period. Each product is described by one or more attributes and attribute values. The computer system further includes a processor configured for performing the steps of the method of the first embodiment.

### BRIEF DESCRIPTION OF THE DRAWINGS

FIG. 1 shows a flowchart of the method of the present invention.

FIG. 2 depicts a graph of an exemplary S-curve showing the tipping point of competitive pressure and price differences.

FIG. 3 is a graphical representation of the decision logic used by the method to perform binning and reduce competing product and competitor sets.

FIG. 4A illustrates a conventional system bus computing system architecture wherein the components of the system are in electrical communication with each other using a bus.

FIG. 4B illustrates an example computer system having a chipset architecture that can be used in executing the described method.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention. The terms ‘competitor pressure’ and ‘competitive pressure’ are taken to signify the same concept, and are used interchangeably in the following text.

The present invention is a method for analyzing large datasets and associated models in order to provide a means for identifying and correcting errors or inconsistencies in an environment where there are competing systems at work. The methodology is potentially applicable to various types of problems involving managing one system in an environment with other competing systems, including problems involving how to
adjust attributes of a system to meet a use or availability target for a resource offered by one system when other systems are present that offer the same or similar resource; or
adjust attributes of a system to meet an throughput or flow target for resources from one or more sources by one system when other systems are present and have their own throughput or flow targets for the resources from the one or more sources.

In other words, there is a class of problems that can involve identifying and correcting errors in setting/configuration for a system operating in an environment with competing systems. Namely, the question is whether a setting or configuration is wrong or right in order to meet a goal or requirement or, alternatively, what should the setting be to achieve the desired goal or requirement? These are problems faced in retail science, manufacturing, distribution, traffic control, utility management, cloud computing, or other environments where a plurality of competing systems exist associated with one or more sources and it is important to select the correct setting or configuration.

For ease of illustration, the remainder of the discussion focuses on a retail science example involving analyses of prices of products and demand models. However, the present disclosure contemplates that the methods described herein are equally applicable to other problems inside or outside of retail science.

In retail science, a demand model is typically a function of price, promotional status, time of year, day of week, etc. There are also models for cannibalization that can be considered and that describe the effect of where one product's price reduction on the sales of other products.

However, as noted above, demand is typically modeled as a function of price. In the case that a competitor does not change and their product offerings or prices do not change, then the price-only model of demand may be accurate. However, competition affects demand, usually adversely, and the effect of competition is typically not accurately captured in a price-only model. For example, if product A is available at a discounted price as compared to equivalent product B, it is likely that sales of product B will decrease. Thus, if competitors are introducing new products or changing their prices for competing products, then a new model is needed that reflects such changes in demand as a function of the change in competitive pressure resulting from the change in prices.

In general, the effect of competitive pressure can be significant and provides a more accurate picture of the competitive environment if modeled and considered when analyzing demand. For example, consider two price decrease scenarios. In the first scenario, there may be a price decrease and one may see a rise in unit sales. However, there may be no adverse affects to the sales of a similar products from competitors, i.e., no significant effect on competitive pressure. For example, this can occur in products where brand loyalty, location, or some other factor is more important than price. In the second scenario, the price decrease may result in a larger rise in unit sales, as compared to the first scenario, and notable or even significant adverse effect on the sales of similar products from other competitors. Thus, the price change also results an improvement in the competitive position as compared to the competitive retailers have not changed their prices. However, the price-only model cannot capture such effects and without considering a model of competitive pressure in modeling demand, it would not be possible to accurately account for the difference between the two scenarios.

In view of the foregoing, one aspect of the present invention is directed to systems and methods that model demand so as to consider the effects of external and internal competitive pressures (i.e., competitor and cannibalization effects, respectively) on demand. Another aspect of the present invention is directed to systems and methods for analyzing and selecting prices of products based on such on improved demand models.

Some retail-science offerings have provided basic models of cannibalization and some basic models of competitive-market sales. However, the basic problem with these phenomena (including affinity) is that they are typically statistically difficult to observe and thus difficult to accurately model. Thus, models for cannibalization and competitive-market sales are not typically accurate or useful. For example, some systems for modeling cannibalization use a single parameter ψ for a collection of products to recapture in other products the lost sales of a single product due to raising its price. If the single-product model changes demand by x from a particular price change, then the rest of the products will absorb ψ of that so the impact of that price change on the collection of products is (1−ψ)x. Unfortunately, this allows no flexibility in which products are more or less affected by what happens to other products. Rather, all products, whether substitutes or not, by this cannibalization modeling scheme.

An alternative is to have a parameter for each product sold and each competing product. This would be ideal for estimating demand. One could combine the total effect of all the competing products and add or multiply that factor to the modeled demand. In this case, it would not matter whether the competing product is from a competitor or not, as the model calculations would be essentially the same. However, the problem here is that there are subtle statistical calculations that need to be performed and potentially a non-trivial number of parameters. For example, just to address cannibalization, each of n products affecting the other n−1 products would generate about n² parameters that we can only estimate through changes in unit sales during price changes. For example, in the cannibalization case, if there are ten products all affecting each other, one could easily end up having to estimate at least 45 parameters. Considering that the same methodology is being applied to consider other competitors' products, it becomes clear that a significant number of parameters would quickly accumulate, resulting in a complex and time-consuming analysis. Thus, performing this type of analysis would result in consumption of a significant amount of computing resources and does not tend towards a stable solution.

Therefore, to address the inefficiencies of such methods, one aspect of the present invention involves reducing the analysis to a small number of parameters with statistical meaning to model demand with cannibalization and competitive price activity over a relatively large number of products and inter-product relationships. Such an approach results in a significant increase in computational efficiency without losing statistical meaning, as the processing and memory resources required for this methodology are significantly lower than those required when a full set of parameters is used.

In view of the foregoing, one aspect of the present invention adds competitor pricing to the mix of model input parameters in such a way that the model parameter for competitor price is reduced to a factor based on competitive pressure. The competitive pressure can be calculated based on what is already known about the competitor rather than wasting statistical resolution solving for what is already known. Furthermore, the same competitive pressure model can then be used to evaluate the competitive pressure from one's own products. In this way, the competitive pressure model described herein can also be used to model cannibalization.

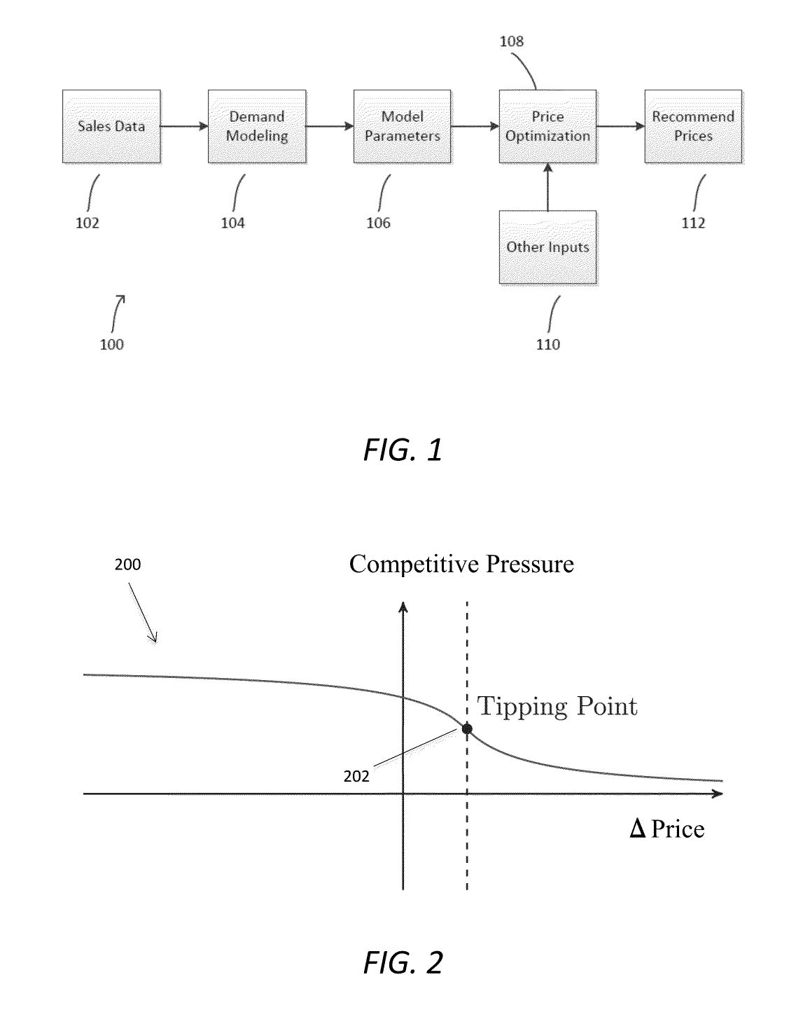

In a particular embodiment of the present invention, a plurality of products and related statistical data form the basis of the large dataset to be analyzed, wherein the product dataset is coupled with an associated model of competitive pressure, thereby allowing for the detection and correction of errors and inconsistencies in proposed price changes for one or more of the products. FIG. 1 is a flowchart that illustrates the general underlying statistical process for applying the present invention to the product dataset in a single iteration, although it is understood that the method may be repeated and applied to the product dataset one or more times.

At a step 102 sales data is collected regarding the plurality of products, the plurality of associated sources for the products, and related statistical data. The plurality of associated sources merely refers to the origin or location of a given product, and may include direct and indirect competitors, but is not limited to such external entities. Sales data corresponds to a specific time period, up to and including the present time period at which the method is executed or caused to update. Sales data may additionally include information such as prices associated with each sale, attributes and attribute values associated with the plurality of products, conversion factors for equivalizing the prices and attribute values, equivalized prices and attribute values, and attribute weights, although one skilled in the art would appreciate the existence of additional related statistical data pertaining to the plurality of products and product sources. This sales data is collected and comprises the large product dataset upon which the present method operates.

At step 104, demand modeling is performed, by first generating a competitor pressure model or value based on the information contained in the sales data and product dataset. The competitor pressure model or value is a constituent component of the demand model, and is calculated from a priori knowledge and statistical estimations, and reduces to a single parameter that is included in the overall demand model. This step of reducing the proliferation of parameters allows the method to perform a detailed and accurate analysis of the product dataset without requiring a large number of parameters. In the various embodiments, each competitor pressure model or value is specific to a product of interest, product source, and time period, and characterizes an estimated variation in demand for the product of interest as a function of variation in price (or proposed price) for the product of interest. A step 106 transmits the specific model parameters for each competitor pressure model, which is subsequently used in a price optimization calculation step 108.

Step 108 performs the price optimization step, in light of the model parameters from 106 and other miscellaneous inputs transmitted in a step 110, which may be performed concurrently with step 106. The miscellaneous inputs may include parameters such as the price optimization goal, a weighted average of profit and revenue, a parameter characterizing an average effect of price on demand, or other instructions for initializing the price optimization step. The optimal price calculation requires a full determination of the impact of a product's price on demand, captured in a single parameter. A first component of this parameter characterizes the average effect of price on demand, which is adjusted by the addition of two further parameters: (1) a first parameter that represents the total contribution of all competitor pressure values across the plurality of products and sources; and (2) a second parameter to explain the effect of cannibalization, i.e., the effect of the proposed price of a product of interest on all other products from the same source as the product of interest. Given these calculated parameters, explained in additional detail below, the optimal price calculations are performed, thereby allowing for the detection and correction of errors and inconsistencies in proposed price changes for one or more of the products and facilitating the generation of recommended prices in step 112.

While pricing calculations are known in the art, previous implementations struggle to predict demand when the behavior of competitors is inconsistent or otherwise unpredictable, which is most often the case in real-world (rather than hypothetical) applications of such calculations. This competitor behavior is characterized by a competitor pressure model or value, which brings a far greater degree of accuracy and robustness to any such pricing calculations. As such, it is an objective of the present invention to implement a pricing calculation capable of accounting for this competitor behavior via an inclusion of a plurality of competitor pressure values. In pricing calculations known to the art, competitor pressure was only an implicit, roughly estimated and accounted for value. In the present invention, competitor pressure is an explicit value derived from a priori knowledge and subsequent statistical modeling. In some embodiments, competitor pressure may also be a pre-defined input or an external calculation subsequent to being input into demand modeling. The competitor pressure values may also be derived from pre-defined data such as graphs or functions related to the plurality of products from the corresponding sources.

When competitor pressure is explicitly calculated and derived, much of the requisite a priori knowledge is contained within the product dataset, which stores past and present data regarding a plurality of products and an associated plurality of product sources, along with related statistical factors and measures. A traditional demand model and price calculation could be derived and performed on this dataset, but the present method forgoes such a step. Rather, the present method removes all known information pertaining to competitive pressure from the demand model and generates an explicit competitor pressure value, wherein the competitor pressure value is based on an understanding of how products compete with each other. The constituent data or information used to construct the competitor pressure value includes, but is not limited to, factors such as product similarity, price equivalence, competitor matching, combined competing products, and combined competing locations.

All products are characterized by one or more product attributes, which are pre-defined and contained within the product dataset, wherein products are further characterized by an attribute value for each of their specific product attributes. For example, if the product is a cola, product attributes might include brand and size, and attribute values might include the specific brands and the different sizes (e.g. 12 oz and 20 oz). Although the examples provided are both tangible product attributes, one skilled in the art will appreciate that product attributes are not limited to tangible or physical properties, and may additionally include intangibles such as return and warranty policies. Given a measure of the product attributes for the plurality of products represented in the product dataset, a product similarity factor is calculated for use in the present method.

Based on their attributes, two products can range from being considered identically similar (a product similarity factor of one) to being considered utterly dissimilar (a product similarity factor of zero), or, most likely, somewhere in between. While the factor ranges between zero and one in the example given, the present invention is not limited to be within such a range, as it is understood that the product similarity factor is a unit less factor that may be scaled as desired. Identical similarity and utter dissimilarity are easily determined, but the degree to which two products are somewhat similar is challenging to quantify, and requires a more concerted statistical modeling effort to determine the interplay between tangentially related or otherwise dissimilar product attributes. To illustrate the effect of product similarity on competitor pressure, consider the earlier example, wherein the only measurable attributes are brand and size. The same brand exerts greater competitor pressure than an alternative brand, and an increasing disparity in sizes means decreasing competitor pressure. This is an expected result—for example, two colas compete more with each other than one cola and one fruit-flavored soda, and 16 oz and 20 oz colas compete more with each other than 12 oz and two-liter sizes. The greater the degree of product similarity between a given product pair, the greater the competitor pressure exerted. As such, the product similarity factor is structured to capture this entire range of effects when it is factored into the overall competitor pressure calculation.

Related to the product similarity factor is a price equivalence factor. All product attributes have price relationships between one another, or in other words, consumers place a different monetary value on one attribute as compared to another. These price relationships are a priori knowledge; either user supplied or previously calculated, and serve to define the price equivalence factor between two products. The price equivalence factor captures the average price relationship between the two products averaged over a plurality of consumers. For example, continuing to use the previous example, cola might have a 20% price premium over fruit-flavored soda, all else equal, and a brand name cola might have a 35% price premium over store-brand cola, all else equal, and the doubling of size might have a 65% price premium. These equivalence relationships are straightforward for product pairs that are clear competitors to one another, but become far more challenging to calculate in circumstances where the degree to which two product pairs are competitors is unclear, and it is this effect that may be captured by comparing given product pairs to the past data contained in the product dataset, and thereby extrapolating a price equivalence relationship based on this past transactional data.

High priced products present an additional challenge to the calculation, as product similarity and price equivalence tend to cancel out for higher-priced products—the products lose similarity as they gain price equivalence. Consider luxury goods, which are highly price equivalent, discretionary purchases. As such, they must rely on a high degree of differentiation (low product similarity) in order to compete at such a high price. On the contrary, low priced items experience product similarity and price equivalence combining effects—if a first competitor is selling a large bottle of cola, a second competitor may need to be nearly at the exact same price in order to compete on the large bottle of cola, whereas the second competitor may need to be more than proportionately cheaper to compete on a small bottle of cola, because it's not the same size.

Competitor matching provides a third factor in the competitor pressure calculation. Not all competitors are able to command the same price for the exact same product, due, for example, to marketing and other perceived brand intangibles that a given competitor has obtained. As such, the competitor pressure calculation must take into account the varying preferences consumers have for different competitors, even when seeking to purchase identical goods. This competitor matching factor is represented and calculated in a manner similar to that described above for price equivalence, wherein it is either user supplied and pre-defined in the system or extrapolated from the stored transaction data in the product dataset.

More important, when dealing with competitor matching is the fact that the influence of price and the specific competitor has a limit, or in other words, that demand is not continuously linear in price. There is a point of maximum price influence, herein referred to as a tipping point, bounded between upper and lower saturation points, beyond which competitive pressure does not accurately account for demand without the consideration of additional factors. This price and competitive pressure relationship is illustrated in FIG. 2 by S-curve 200, wherein the positive x-axis represents higher competitor prices and the negative x-axis represents lower competitor prices.

Each S-curve is specific to a given product of interest, and tipping point 202 indicates the price difference between competitors that has the maximum influence on competitive pressure. For example, if $1.80 is the match price considering both price equivalence and competitor matching, then the maximum price influence will be located around $1.80 with diminishing returns seen on either side of that price. However, the effect is limited because some shoppers will not switch between competitors no matter how favorable the price difference is. This saturation of pressure with price is represented graphically by the asymptotic tendency to a fixed visible at both extremes along the x-axis. No matter how high a price is raised, some consumers will not switch to a different competitor, and likewise, no matter how low a price is dropped, some consumers will not switch away from a different competitor.

The competitor pressure calculation seeks to reduce the proliferation of parameters, and combined competing products provide one means to do so. While a simplistic approach would evaluate competitor pressure from a competitor simply as the sum of all the individual competitor pressures of its constituent products available for purchase, this view is overly reductive and fails to account for the strong similarity effects that can exist between competing. Two fully similar competing products provide no more competitor pressure than just a single one of the products, and only two fully different competing products experience a full additive effect of their competitor pressures. To combine competing products, the method uses the previously discussed factors of product similarity and price equivalence to define a vector direction for each of the competing products to be combined. These vector directions are then used to adjust the magnitude of the combined competitor pressures from all of the competing products to be combined. In some embodiments, the competitor pressure values may be pre-defined or calculated, and their use in the presently described calculations is unaffected by the source of the competitor pressure values used as input. The competitor pressure values may also be derived from pre-defined data such as graphs or functions related to the plurality of products from the corresponding sources.

As a basic illustration, two bigger products or two better-brand products cause about the same competitive pressure as a single one of them, and as such, one of the products is in the competitive shadow of the other, and is irrelevant for the sake of the competitor pressure calculation because its effect is wholly dominated by that of the more competitive product. Two products that differ differently, however, like one bigger and one smaller, would have an additive competitor pressure close to the sum of their two individual competitive pressures.

Prior to combining the competing products, the method uses the product similarity factors and price equivalence factors as two conversion factors for equivalizing the prices and values of the competing products with respect to the product of interest. Having been equivalized, the only remaining difference to account for is that of competitor pressure—and it is this combining step that distills the plurality of competitor pressure values into a single competitor pressure model or value. From this point onward, subsequent analysis takes place using these equivalized prices and attribute values.

Consider product attributes Alpha and Beta where the product of interest has a value of 100 Alpha and a value of 100 Beta, and is priced at $100. If a competitor has a product with a value of 120 Alpha and a value of 80 Beta, priced at $90 that creates some competitor pressure P, then their second product with 120 Alpha and 80 Beta, priced at $90 does not increase the competitor pressure beyond P, because it falls in the competitive shadow of the first product. On the other hand, a third product with 120 Alpha and 120 Beta goes in a different competitive direction and would not be shadowed, or not completely shadowed, by any of the competing products described above, and as such would need to be accounted for when combining competitor pressures for competing products.

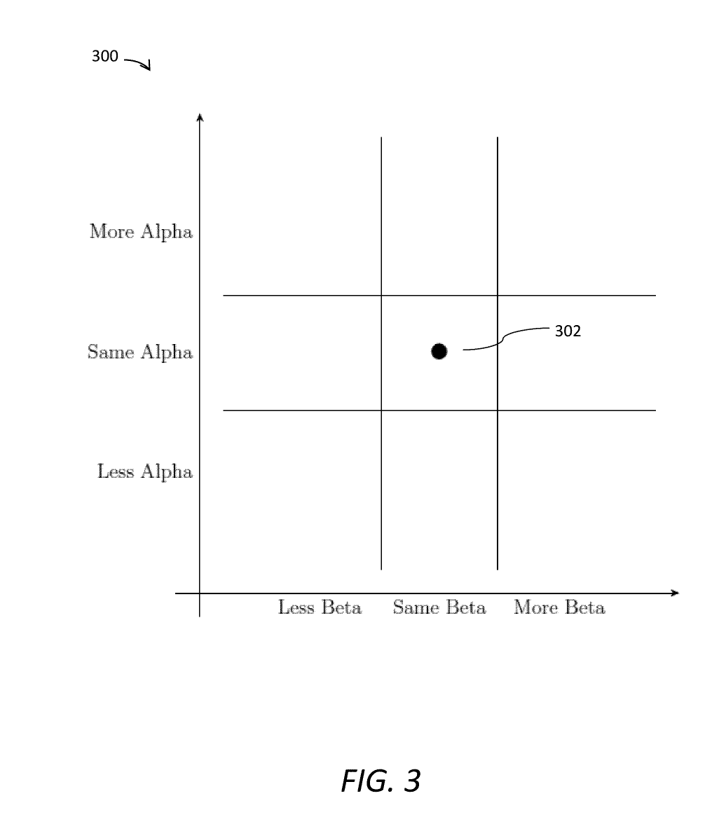

FIG. 3 illustrates the underlying logic behind the combining of competing products, wherein a grid 300 is used to represent the different product groupings analyzed by the method. For all possible combinations of two product attributes, all of the product attributes may be sorted into one of nine categories, with each category being constructed relative to the attributes of a product of interest 302. For example, consider attribute Alpha and attribute Beta. Relative to the product of interest 302, each competing product may have more Alpha and/or Beta, less Alpha and/or Beta, or the same Alpha and/or Beta. The competing products are not shown in FIG. 3, but it is understood that each competing product would be sorted into one of the distinct bins of grid 300.

The products within each bin are defined as a set of competing products—the original set of competing products to be analyzed relative to the produce of interest has now been broken down into nine sub-sets of competing products. The method considers each of the nine-subsets independently, using the vector direction and competitive shadow calculation described above to reduce each sub-set to a single competitor pressure value. Thus, for all two-element attribute pairs, influence on the competitor pressure is reduced to just nine values. Recalling that these nine values are calculated for nine sub-sets of the original set of competing products to be analyzed, the nine values may then be subsequently weighted and summed to a single competitor pressure value for the original set of competing products. The weights may be pre-defined or calculated, but it is understood that the bin containing the product of interest 302, and also containing all products identical to product of interest 302, receives the highest weighting. The remaining eight bins all receive a lower weighting, as they contain products that are attenuated by one or more attribute differences. Moreover, the weighting of such remaining bins can vary. For example, the remaining bins with the same Alpha or Beta may have a greater weight than the remaining bins with differences in both α and β. Alternatively, the weights can be specified as a function of difference in Alpha and/or Beta. Thus, as the difference in Alpha and/or Beta increase, the lower the weight. One skilled in the art will appreciate that in large environments with many competitors, the present method may easily reduce the parameter space by several orders of magnitude.

Combined competitor locations are generated in a similar manner as the combined competing products. Competitor locations that share the same shopping community may be treated as a single competitor, where the competition faced is simply the lowest price amongst all of the competitor locations. However, if the competitor locations are distinct, far-apart geographic locations, then each of the same competitor's locations may represent a nearly independent competitor. Combing competing locations aids in the reduction of the proliferation of parameters, as competing locations are far more commonly locating within the same retail community, rather than in far apart geographic locations. In some embodiments of the present invention, competitor attributes may be defined and analyzed using a logic similar to that illustrated and explained above with respect to FIG. 3.

A practitioner of the method may also treat his own assortment of products as competitors to one another and thereby calculate a cannibalization model to explain the effect of a change in the price of a product of interest on the demand for the remainder of products drawn from the same product source or assortment, using the same competitor analysis logic described above. Recalling that competitor pressure is a demand influencing factor that is input into the demand model and price optimization, every competitor (now including the cannibalization competitor) has a competitor pressure value, pᵢ, that can be calculated for each product, store, and time period using the methodology described above.

That is, each competitor i may have an assortment of products that can be analyzed using the binning framework depicted in FIG. 3. For each product, competitor pressure can be defined by pre-defined values for different bins. Alternatively, competitor pressure can be defined by a distance from the product of interest 302 located in the center square. Each competing product has a distance attribute relative to the product of interest, and competitor pressure drops off from its maximal value according to a pre-determined reduction based on its distance attribute. Because most competing products have more than the two attributes analyzed at once by the binning framework, a competing product's total competitor pressure relative to the product of interest is calculated over all of the possible attribute pairs, wherein the different competitor pressure values are summed according to their vector direction. Once the net competitor pressure value for each of the competing products is determined, all of the competing products from the given competitor may be analyzed en masse against the product of interest in a single step, or they may be sub-divided into groups of more closely competing products that are analyzed and condensed into competitor pressure values that are then analyzed against the product of interest. In either instance, the analysis yields a single value pᵢ for competitor pressure for each competitor i. In addition to being a function of the competitor i, the competitor pressure pᵢ is additionally a function of time period and the product of interest.

Given the competitor pressure pᵢ for each competitor i, the method then implements demand modeling, which begins with considering a traditional price-demand model where economic elasticity E is linear in price P:

E=β₀P. (3)

Thus, demand D is an exponential function of the price and the demand model:

D=Qe^{-β}^{₀}^{P} (4)

where Q is the scale term describing much capacity would be taken if the product of interest were free (P=0). Note that β₀ in both Equation (3) and (4) considers every issue surrounding and impacting price, and is a generic estimated term, meaning that it includes the implicit definition of competitor pressure described earlier, rather than the explicit definition pᵢ of the present invention. A fully comprehensive model of demand includes additional seasonality and trend terms that are not shown her for simplicity's sake, although one skilled in the art will appreciate that their inclusion or lack thereof does not substantially impact the present disclosure.

In order to account for competitor pressure, a competitor cross elasticity term γᵢ for each competitor i is defined wherein the cross elasticity term may be thought of as an importance weight for each competitor as seen from the perspective of the competitor offering the product of interest, or alternatively, a measure of how effective competitor i is as a competitor against the product of interest. For example, if product A is sold by competitor 1 and would normally provide a high competitor pressure to similar product B sold be competitor 2, because of the location of competitor 1 or some other factor, the sales of product A are not relevant to the sales of product B. Thus, the competitor cross elasticity term γᵢ can be selected or calculated to capture this effect, wherein the elasticity term is either pre-defined as an input or is determined through a statistical modeling effort of sales data, graphs, or functions. In the example above, γᵢ for competitor 1 might be set to a low value to offset the competitor pressure of product A.

The demand model is then updated to include this appropriately weighted, explicit definition of competitor pressure γᵢpᵢ for each competitor i, including the cannibalization competitor:

D=Qe^{-τ}^{ᵢ}^{γ}^{ᵢ}^{p}^{ᵢ}^{^{−βP}} (5)

where Q is still a scale term, and β here only consider the issues surrounding and impacting price that are not explained by competitor pressure. As such, β is not the same as the β₀ from Equations (3) and (4). In other words, β represents the influence of price on demand with competition filtered out and the effects of competition are instead accounted for in the γᵢpᵢ term. Thus, the demand model, as utilized in the present invention, is generated from Equation (5). In some embodiments, a regression analysis can be used to solve for γᵢ for a given β and price P. Once this competitor cross elasticity term γᵢ is known and a demand model accounting for competitor pressure can be provided.

Such a demand model has a large number of uses. In some aspects of the present invention, the demand model can be utilized to calculate an optimal price for a product so that competitive pressures are considered.

Typically, price-optimization involves maximizing a weighted average λ of revenue (λ=0) and profit (λ=1). λ is a global parameter defining the importance of revenue to profit. In some instances, it can be product specific, but is generally the same at least across a whole sub-category of products. Ideally, λ should be the same across the entire product range of the competitor selling the product of interest. For ease of explanation, the following discussion will assume a constant λ.

In a traditional exponential model of price, the optimal price P* based on cost C is:

$${P}^{*} = λ C + \frac{1}{{β}_{0}} , \qquad ( 6 )$$

where

$$α = \frac{1}{{β}_{0}}$$

is a willingness-to-pay amount.

As discussed above, increased competitive pressure is expected to drive prices down, an intuitive observation that is also supported by the Equation (5). As before with Equations (3) and (4), the β₀ of Equation (6) does not separately account for the explicit competitor pressure calculation of the present invention. Accordingly, the present disclosure contemplates using a new coefficient \hat{β} in place of β₀ to reflect the full impact of a product's price on demand. In particular, \hat{β}=β+β₁−β₂, where β is the same as in Equation (5), β₁ is a contribution from the competitors i, and β₂ is a cannibalization effect on one's own products j. These terms are both functions of price, but the price changes involved in a typical retail price optimization problem are so small that their effect is negligible, and so may be regarded as constant. The specific definitions of the two new terms are as follows:

$$\begin{matrix}{β}_{1} = {\sum }_{i} {γ}_{i} \frac{d {p}_{i}}{d P} & ( 7 ) \\ {β}_{2} = {\sum }_{j} {γ}_{0 , j} \frac{d {p}_{0 , j}}{d P} \frac{( {P}_{j} - λ {C}_{j} )}{( P - λ C )} \frac{{w}_{j}}{{w}_{0}} & ( 8 )\end{matrix}$$

Note that both terms reflect the derivative of competitor pressure with respect to price, multiplicatively scaled by a cross elasticity value, and are calculated over each competitor i.

β₁ is calculated over all of the competitors i, including the cannibalization competitor, and represents the total outside competitive pressure. Because these outside competitive pressures are highly correlated with price elasticity, the sum β+β₁ is more stable than either term by itself, and is approximately equal to β₀.

β₂ represents the effect of cannibalization on other products j, and consequently contains no i terms relating to other competitors (in this calculation the other competitors are not important or considered since their impact is included in β₁). When the price is raised on one product, demand is lost on that product, but some of the lost demand goes to other products from the same product offering line, in an effect known as recapture. As such, β₂ must account for effects across the entire range of the product line, and is therefore calculated via a matrix transpose. Here, β₂ considers the effect of a product price on demand for other products rather than the effect of other product prices on the demand for the product of interest. This involves the price P and cost C for the product of interest, other product prices Pⱼ and costs Cⱼ, and the cross elasticity or coefficient of pressure γ_{0,j} of the product of interest on product j. Similar to the competitor cross elasticity, this factor describes the relative importance or effectiveness of a product j's competitive effect on the product of interest. The derivative of the competitor pressure between product j and the product of interest, p_{0,j}, is taken with respect to changes in the price of the product of interest. The weight term wⱼ/w₀ reflects some measure of the relative importance of each product, for example, revenue, profit, units, or some other combination of measures.

In capturing the cannibalization effect, β₂ represents the amount of damage that may be caused by cannibalization when prices are changed—for this reason it is subtracted from the overall \hat{β} coefficient. As may be observed from Equation (6), all else equal, high cannibalization products require higher prices to be kept—if their price is dropped, they will strongly cannibalize sales from the same product offering and have a detrimental impact on the profit-revenue balance. On the other hand, low cannibalization products may be marked down with relatively little concern—their price drop will result in increased demand for that specific product, but not at the expense of other products from the same product offering. By incorporating this cannibalization factor in the optimal price calculation, along with the competitor pressure calculation used in the demand calculation and cross elasticity regression analysis, the present invention allows for a far more comprehensive analysis of the large product dataset, more accurately analyzing the effect of a proposed price change on a given product of interest and thereby generated a set of recommended prices to correct any detected errors in the proposed price changes.

### Examples

The following examples and results are presented solely for illustrating the various embodiments and are not intended to limit the various embodiments in any way.

Consider a retail environment with only two competitors, A and B, wherein competitor A is a practitioner of the present invention, and further where the two competitors compete on the same, identical product. To practice the present invention, competitor A must collect sales data. The sales data collected by competitor A cover an eight week period, and at a most basic level, includes product sales and the two prices in the market. Furthermore, price changes seen in the sales data do not reflect price changes that were analyzed using the present invention, although it is understood that the method applies equally regardless of the basis behind any price changes. The sales data are presented in the table below:

| | Week | | | | | | | |
|---|---|---|---|---|---|---|---|---|
| Competitor | 1 | 2 | 3 | 4 | 5 | 6 | 7 | 8 |
| A, Sales | 100 | 100 | 100 | 100 | 144 | 144 | 123 | 123 |
| A, Price ($) | 10 | 10 | 10 | 10 | 8 | 8 | 8 | 8 |
| B, Price ($) | 10 | 10 | 10 | 10 | 10 | 10 | 8 | 8 |

While the sales data may include the number of competitor sales, or an estimate of the number of competitor sales, the information is not included in the present example as a simplifying means. Turning to the data, it is seen that competitors A and B matched prices for the first four weeks, at $10. During this stable period of price matching, competitor A saw a steady demand of 100 units per week. However, beginning in week 5, competitor A dropped its price to $8 and saw demand increase to 144 units per week, with the additional 44 units of demand being captured from other competitors, or in this case, from competitor B. In week 7, after a two week lag, competitor B began matching competitor A by also pricing at $8. As expected, competitor A saw a decrease in demand relative to the previous two weeks, with demand dropping to 123 units, with the 21 units of demand being captured by other competitors, or in this case, by competitor B. Averaging over the past eight weeks, competitor A has seen a price of $10 yield a demand of 100 units and a price of $8 yield a demand of 133.5 units.

Given this sales data, competitor A needs to determine an optimal price to set for an upcoming week 9. One option would be to use the simple demand model of Equation (4), recalling that this model does not account for an explicit measure of competitor pressure, and instead relies on a statistical estimation to approximate competitor pressure within a blanket parameter β₀. Using its own sales data and fitting to this model, competitor A finds that Q=424 and β₀=0.144 yield a reasonable fit. With these model parameters, competitor A obtains a pricing forecast of 116 units for a price of $9.

However, as stated previously, this simple demand model does not account for competitor actions—by ignoring the prices of competitor B, the model does not incorporate a true measure of competitor pressure. It is important for competitor A to obtain the most accurate pricing forecast possible in furtherance of its goal of efficient business operations, and as such, competitor A implements the method of the present invention.

Because the products are identical, the competitor pressure from a price match is 1.0. In the case of the price mismatch, where competitor A priced at $8 and competitor B priced at $10, a competitor pressure value may be calculated. Using knowledge of attributes of competitor B, competitor A calculates the competitor pressure to be 0.2 for the $8 and $10 price mismatch.

With this competitor pressure value, competitor A may now use Equation (5) of the present invention, fitting to yield Q=333, γ=0.2, and β=0.1. These model parameters characterize the retail environment during weeks 5 and 6 only, when the price mismatch was present. However, the gamma value calculated may be re-used in subsequent calculations, or used as a reference point when making any small adjustments or corrections.

With these new model parameters, competitor A can begin to analyze pricing decisions for the upcoming week 9. Still contemplating the price increase to $9, and recalling that the simple demand model forecast 116 units of demand, competitor A calculates a new competitor pressure value for a $9 and $8 price pair between itself and competitor B. Building off of its earlier competitor pressure calculation, competitor A determines that the competitor pressure value is 0.5.

Using this value and the known gamma value, the improved demand model forecasts a demand of only 100 units for week 9, pricing at $9 while competitor B prices at $8. This forecast differs sharply from the simple demand forecast of 116 units of demand, to the point where competitor A would likely make different decisions on whether or not to price at $9 depending on which forecast was used.

As examples of further outputs of the advanced demand model that may be used to determine optimal price, if competitor B raises its price and matches at $9, then competitor A will forecast a demand of 111 units per week. If, after matching prices at $9, competitor B then changes its product offering such that the new product similarity factor is only 10%, then competitor A will forecast a unit demand of 133 units per week. Because the demand model of the present invention accounts for competitor pressure, it not only offers greater accuracy in demand forecasts, but it additionally offers forecasts and insights into a far greater breadth of scenarios, which enables an improved determination of optimal price by a practitioner of the method.

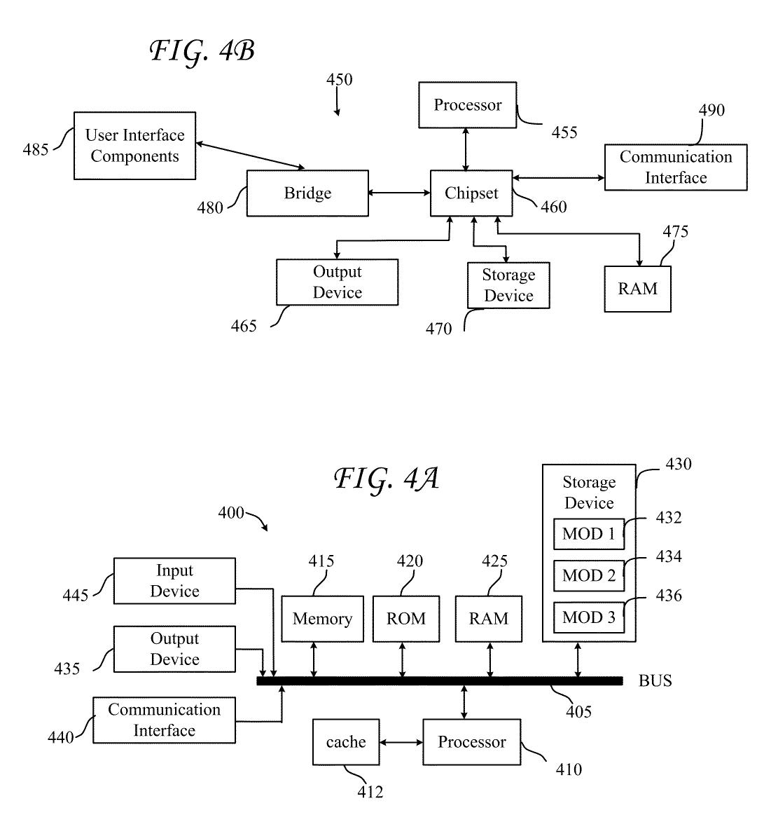

FIG. 4A and FIG. 4B illustrate example system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates an example computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output device 465, such as a display, and can read and write information to storage device 470, which can include magnetic media, and solid state media, for example. Chipset 460 can also read data from and write data to RAM 475. A bridge 460 for interfacing with a variety of user interface components 465 can be provided for interfacing with chipset 460. Such user interface components 465 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 465 and execute appropriate functions, such as browsing functions by interpreting these inputs using processor 455.

It can be appreciated that example systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims. Moreover, claim language reciting “at least one of” a set indicates that one member of the set or multiple members of the set satisfy the claim.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. Also, the terms “about”, “substantially”, and “approximately”, as used herein with respect to a stated value or a property, are intend to indicate being within 20% of the stated value or property, unless otherwise specified above. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method, comprising:
obtaining, for each of a plurality of products related to a product of interest, a number of sales during a selected time period, prices associated with each of the sales, and values for one or more attributes associated with the plurality of products;
applying conversion factors for equivalizing the prices and the values with respect to the product of interest and to yield equivalized prices and equivalized values;
selecting attribute weights for each of the attributes, each of the attribute weights characterizing a relevance of corresponding one of the attributes to sales of the product of interest; and
based on the number of sales, the equivalized prices, the equilavized values, and the attribute weights, generating a competitor pressure model for the product of interest describing an estimated variation in demand for the product of interest as a function of variation in price for the product of interest.

2. The method of claim 1, further comprising:
obtaining a proposed price change for the product of interest; and
based on the competitor pressure model and the proposed price change, estimating an effect of the proposed price change on the demand for the product of interest.

3. The method of claim 1, wherein the competitor pressure model is selected to have a form comprising an S-function.

4. The method of claim 1, wherein the plurality of related products are associated with a plurality of sources.

5. The method of claim 1, further comprising calculating an optimal price for a product associated with the plurality of related products using:
P*=λC+1/\hat{β}
where P* is the optimal price, C is a cost of the product, λ is a weighted average of revenue and profit, and 1/\hat{β} is a willingness-to-pay amount, where \hat{β}=β+β₁−β₂, where β₁ is a factor describing outside competitor pressure, where β₂ is a factor describing cannibalization, and β is a non-competitive factor according to:
D=Qe^{-τ}^{ᵢ}^{γ}^{ᵢ}^{p}^{ᵢ}^{^{−βP}}
where D is observed demand for the product of interest during the selected time period, P is price for the product of interest during the selected time period, pᵢ is the competitor pressure of an ith of the plurality of products according to the model during the selected time period, and γᵢ is an elasticity term for the ith of the plurality of products during the selected time period, and Q is a scale term describing demand when P=0.

6. The method of claim 5, wherein the outside competitor pressure factor (β₁) is defined by:
$${β}_{1} = {\sum }_{i} {γ}_{i} \frac{d {p}_{i}}{d P}$$
wherein the plurality of products for generating the competitor pressure model for obtaining γᵢ and pᵢ are associated with one or more sources other than a source of the product of interest.

7. The method of claim 5, wherein the cannibalization factor (β₂) is defined by:
$${β}_{2} = {\sum }_{j} {γ}_{0 , j} \frac{d {p}_{0 , j}}{d P} \frac{( {P}_{j} - λ {C}_{j} )}{( P - λ C )} \frac{{w}_{j}}{{w}_{0}}$$
where Pⱼ is a price of a jth one of the plurality of related products during the selected time period, Cⱼ, is a cost of the jth one of the plurality of related products during the selected time period, γ_{0,j} is an elasticity term for the jth one of the plurality of products from a source of the product of interest, p_{0,j} is the competitor pressure for the jth one of the plurality of products from the source of the product of interest, and wⱼ/w₀ is a weight reflecting the relative importance of the the jth one of the plurality of products from the source of the product of interest,
wherein the plurality of products associated with the competitor pressure model for obtaining γ_{0,j} and p_{0,j} are associated with the source of the product of interest.

8. The method of claim 5, further comprising calculating γᵢ for each of the plurality of products based on a regression analysis of:
D=Qe^{-τ}^{ᵢ}^{γ}^{ᵢ}^{p}^{ᵢ}^{^{−βP}}

9. A non-transitory computer readable medium containing instructions for causing a computer to perform the steps of:
obtaining, for each of a plurality of products related to a product of interest, a number of sales during a selected time period, prices associated with each of the sales, and values for one or more attributes associated with the plurality of products;
applying conversion factors for equivalizing the prices and the values with respect to the product of interest and to yield equivalized prices and equivalized values;
selecting attribute weights for each of the attributes, each of the attribute weights characterizing a relevance of corresponding one of the attributes to sales of the product of interest; and
based on the number of sales, the equivalized prices, the equilavized values, and the attribute weights, generating a competitor pressure model for the product of interest describing an estimated variation in demand for the product of interest as a function of variation in price for the product of interest.

10. The non-transitory computer readable medium of claim 9, further comprising instructions for:
obtaining a proposed price change for the product of interest; and
based on the competitor pressure model and the proposed price change, estimating an effect of the proposed price change on the demand for the product of interest.

11. The non-transitory computer readable medium of claim 9, wherein the competitor pressure model is selected to have a form comprising an S-function.

12. The non-transitory computer readable medium of claim 9, wherein the plurality of related products are associated with a plurality of sources.

13. The non-transitory computer readable medium of claim 9, further comprising instructions for calculating an optimal price for a product associated with the plurality of related products using:
P*=λC+1/\hat{β}
where P* is the optimal price, C is a cost of the product, λ is a weighted average of revenue and profit, and 1/\hat{β} is a willingness-to-pay amount, where \hat{β}=β+β₁−β₂, where β₁ is a factor describing outside competitor pressure, where β₂ is a factor describing cannibalization, and β is a non-competitive factor according to:
D=Qe^{-τ}^{ᵢ}^{γ}^{ᵢ}^{p}^{ᵢ}^{^{−βP}}
where D is observed demand for the product of interest during the selected time period, P is price for the product of interest during the selected time period, pᵢ is the competitor pressure of an ith of the plurality of products according to the model during the selected time period, and γᵢ is an elasticity term for the ith of the plurality of products during the selected time period, and Q is a scale term describing demand when P=0.

14. The non-transitory computer readable medium of claim 13, wherein the outside competitor pressure factor (β₁) is defined by:
$${β}_{1} = {\sum }_{i} {γ}_{i} \frac{d {p}_{i}}{d P}$$
wherein the plurality of products for generating the competitor pressure model for obtaining γᵢ and pᵢ are associated with one or more sources other than a source of the product of interest.

15. The non-transitory computer readable medium of claim 13, wherein the cannibalization factor (β₂) is defined by:
$${β}_{2} = {\sum }_{j} {γ}_{0 , j} \frac{d {p}_{0 , j}}{d P} \frac{( {P}_{j} - λ {C}_{j} )}{( P - λ C )} \frac{{w}_{j}}{{w}_{0}}$$
where Pⱼ is a price of a jth one of the plurality of related products during the selected time period, Cⱼ is a cost of the jth one of the plurality of related products during the selected time period, γ_{0,j} is an elasticity term for the jth one of the plurality of products from a source of the product of interest, p_{0,j} is the competitor pressure for the jth one of the plurality of products from the source of the product of interest, and wⱼ/w₀ is a weight reflecting the relative importance of the jth one of the plurality of products from the source of the product of interest,
wherein the plurality of products associated with the competitor pressure model for obtaining γ_{0,j} and p_{0,j} are associated with the source of the product of interest.

16. The non-transitory computer readable medium of claim 13, further comprising instructions for calculating γᵢ for each of the plurality of products based on a regression analysis of:
D=Qe^{-τ}^{ᵢ}^{γ}^{ᵢ}^{p}^{ᵢ}^{^{−βP}}.

17. A computer system comprising:
a storage device containing data related to each of a plurality of products related to a product of interest, the data comprising a number of sales during a selected time period, prices associated with each of the sales, and values for one or more attributes associated with the plurality of products;
a processor operatively coupled to the storage device, the processor configured to:
apply conversion factors for equivalizing the prices and the values with respect to the product of interest and to yield equivalized prices and equivalized values;
select attribute weights for each of the attributes, each of the attribute weights characterizing a relevance of corresponding one of the attributes to sales of the product of interest; and
based on the number of sales, the equivalized prices, the equilavized values, and the attribute weights, generate a competitor pressure model for the product of interest describing an estimated variation in demand for the product of interest as a function of variation in price for the product of interest.

18. The computer system of claim 17, wherein the processor is further configured to:
obtain a proposed price change for the product of interest; and
based on the competitor pressure model and the proposed price change, estimate an effect of the proposed price change on the demand for the product of interest.

19. The computer system of claim 17, wherein the processor selects the competitor pressure model to have a form comprising an S-function.

20. The computer system of claim 17, wherein the plurality of related products are associated with a plurality of sources.

21. The computer system of claim 17, wherein the processor is further configured to calculate an optimal price for a product associated with the plurality of related products using:
P*=λC+1/\hat{β}
where P* is the optimal price, C is a cost of the product, λ is a weighted average of revenue and profit, and 1/\hat{β} is a willingness-to-pay amount, where \hat{β}=β+β₁−β₂, where β₁ is a factor describing outside competitor pressure, where β₂ is a factor describing cannibalization, and β is a non-competitive factor according to:
D=Qe^{-τ}^{ᵢ}^{γ}^{ᵢ}^{p}^{ᵢ}^{^{−βP}}
where D is observed demand for the product of interest during the selected time period, P is price for the product of interest during the selected time period, pᵢ is the competitor pressure of an ith of the plurality of products according to the model during the selected time period, and γᵢ is an elasticity term for the ith of the plurality of products during the selected time period, and Q is a scale term describing demand when P=0.

22. The computer system of claim 21, wherein the processor is further configured to define the outside competitor pressure factor (β₁) by:
$${β}_{1} = {\sum }_{i} {γ}_{i} \frac{d {p}_{i}}{d P}$$
wherein the plurality of products for generating the competitor pressure model for obtaining γᵢ and pᵢ are associated with one or more sources other than a source of the product of interest.

23. The computer system of claim 21, wherein the processor is further configured to define the cannibalization factor (β₂) by:
$${β}_{2} = {\sum }_{j} {γ}_{0 , j} \frac{d {p}_{0 , j}}{d P} \frac{( {P}_{j} - λ {C}_{j} )}{( P - λ C )} \frac{{w}_{j}}{{w}_{0}}$$
where Pⱼ is a price of a jth one of the plurality of related products during the selected time period, Cⱼ is a cost of the jth one of the plurality of related products during the selected time period, γ_{0,j} is an elasticity term for the jth one of the plurality of products from a source of the product of interest, p_{0,j} is the competitor pressure for the jth one of the plurality of products from the source of the product of interest, and wⱼ/w₀ is a weight reflecting the relative importance of the jth one of the plurality of products from the source of the product of interest,
wherein the plurality of products associated with the competitor pressure model for obtaining γ_{0,j} and p_{0,j} are associated with the source of the product of interest.

24. The computer system of claim 21, wherein the processor is further configured to calculate γᵢ for each of the plurality of products based on a regression analysis of:
D=Qe^{-τ}^{ᵢ}^{γ}^{ᵢ}^{p}^{ᵢ}^{^{−βP}}.
